(19) United States
(12) Patent Application Publication
(10) Pub. No.: US 2013/0271994 A1
(43) Pub. Date: Oct. 17, 2013

(54) LIGHT SOURCE STRUCTURE OF PROJECTOR

(71) Applicants: CHIEN-WEN HSU, Tu-Cheng (TW); WEN-PIN YEH, Tu-Cheng (TW)

(72) Inventors: CHIEN-WEN HSU, Tu-Cheng (TW); WEN-PIN YEH, Tu-Cheng (TW)

(73) Assignee: HON HAI PRECISION INDUSTRY CO., LTD., Tu-Cheng (TW)

(21) Appl. No.: 13/531,108

(22) Filed: Jun. 22, 2012

(30) Foreign Application Priority Data
Apr. 11, 2012 (TW) 101112711

(51) Int. Cl. F21V 5/04

(52) U.S. Cl. 362/259; 362/311.02; 362/244

(57) ABSTRACT

A light source structure of a projector includes at least a solid state lighting element, at least an optical collimator lens, and at least a micro-lens. The solid state lighting element generates a plurality of radial beams, which are incident to the optical collimator lens. The optical collimator lens converts the radial beams into a plurality of parallel beams which successively strike the micro-lens. The parallel beams are concentrated and focused by the micro-lens into a projecting beam.

### BACKGROUND

1. Technical Field

The disclosure is related to a light source structure of a projector, and particularly to a light source structure having solid state light elements and parallel beams for transmission.

2. Description of Related Art

Critical requirements for light sources for projectors are high brightness level and high luminance. Light sources for projectors include non-solid state lighting sources or solid state lighting sources. Current non-solid state lighting sources, including tungsten-halogen lamps, metal-halogen lamps, high-pressure mercury-vapor lamps, xenon lamps, have defects of heat generation, bulkiness, and energy consumption. Although non-solid state lighting sources have high brightness level and require elliptical reflectors or parabolic reflectors to reflect the radial beams into parallel beams for further projection, non-solid state lighting sources contain toxic substance, such as mercury that is un-recyclable and causes environmental contamination

Since electronic products are getting lighter, smaller and thinner, recent projectors use solid state light devices, including light-emitting diodes, or laser diodes, to replace conventional non-solid state lighting sources. Solid state lighting sources have high color saturation; however, they lack elliptical reflectors or parabolic reflectors to enhance luminance. Therefore, it is desirable to have light source structures of high brightness, high luminance, and less contamination for projectors.

### BRIEF DESCRIPTION OF THE DRAWINGS

The components in the drawings are not necessarily drawn to scale, the emphasis instead being placed upon clearly illustrating the principles of a light source structure of a projector. Moreover, in the drawings, like reference numerals designate corresponding parts throughout the several views.

FIG. 1 is a cross-sectional diagram illustrating a light source structure of a projector of the disclosure.

FIG. 2 is a rear view diagram illustrating the light source structure.

### DETAILED DESCRIPTION

The disclosure will be described with references to the accompanying diagrams.

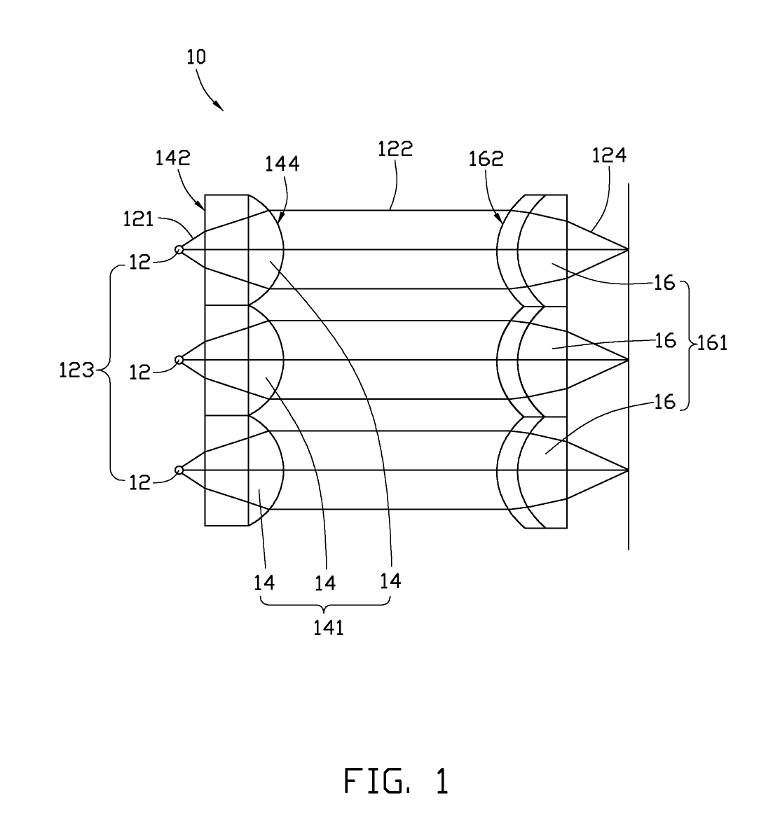

FIG. 1 shows a cross-sectional diagram of a light source structure 10 of a projector. The light source structure 10 includes at least one solid state light element 12, at least one optical collimator lens 14 and at least one micro-lens 16. Each solid state light element 12 is aligned with one corresponding optical collimator lens 14 and one corresponding micro-lens 16. In other words, the optical collimator lens 14 is positioned in front of the solid state lighting element 12, and the micro-lens 16 is positioned in front of the optical collimator lens 14. The optical collimator lens 14 and the micro-lens 16 may use same type of lenses. Each solid state light element 12 generates a plurality of radial beams 121, which are incident to the corresponding optical collimator lens 14. The optical collimator lens 14 converts the radial beams 121 into a plurality of parallel beams 122 that strike the corresponding micro-lenses 16. The micro-lens 16 focuses the parallel beams 122 into a projecting beam 124. The projecting beam 124 is projected on an image display device of the projector (not shown) to display images.

The solid state light elements 12 may be light emitting diodes or a laser light elements to generate the radial beams. The number of the solid state light elements 12 may be modified depending on requirements of brightness and luminance.

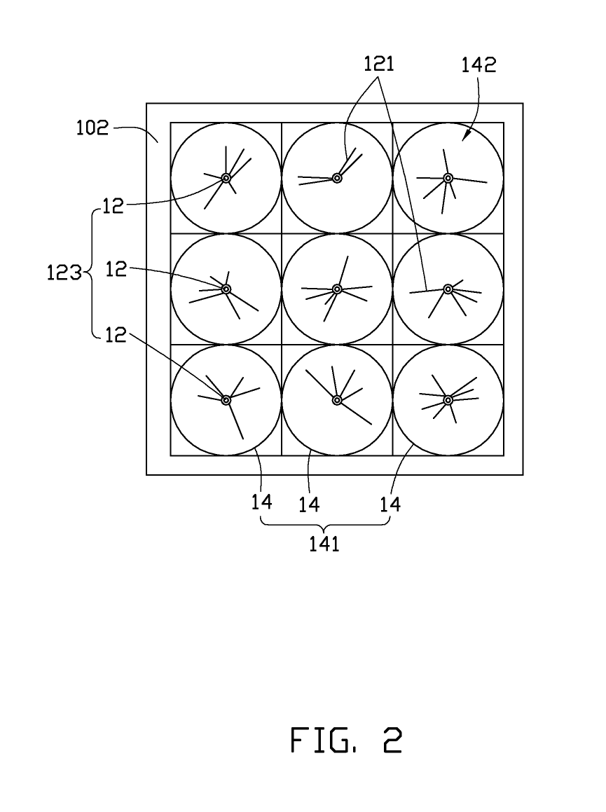

In the present embodiment, the light source structure 10 has a plurality of solid state light elements 12 arranged as a solid state lighting array 123. The solid state lighting array 123 is a 3×3 square array having three solid state light elements 12 on each side (see FIG. 2). The solid state light elements 12 are electrically connected and simultaneously generate radial beams 121 of required brightness and color saturation. Similarly, the optical collimator lenses 14 of the present embodiment are arranged as an optical collimator lens array 141 corresponding to the solid state lighting array 123. The optical collimator lens array 141 is a 3×3 square array having three optical collimator lenses 14 on each side. The optical collimator lenses 14 are placed and constructed in a lattice frame 102. In addition, the micro-lenses 16 of the present embodiment are arranged as a. micro-lens array 161 corresponding to the optical collimator lens array 141. The micro-lens array 161 is a 3×3 square array having three micro-lenses 16 on each side, similar to the solid state lighting array 123 and the optical collimator lens array 141.

Accordingly, each optical collimator 14 is positioned in a light path of a bundle of the radial beams 121. The radial beams 121 are incident into the optical collimator lens 14 from a first incident surface 142 facing the solid state light element 12, passing through the optical collimator 14, and exit from a first exiting surface 144 opposite to the first incident surface 142. The radial beams 121 are converted into parallel beams 122 and project to a second incident surface 162 of the micro-lenses 16. The micro-lenses 16 then concentrate and focus the parallel beams 122 into projecting beams 124 for further image projection.

The light source structure 10 of the disclosure uses the optical collimators 14 to convert radial beams 121 into parallel beams 122 for transmission. The light source structure 10 uses solid state light devices 12 because they contain no harmful substances such as mercury. Assembly of solid state light devices 12 as the main component of the light source structure 10 not only provides light sources of high brightness, high luminance and color saturation, but also is preferable from the viewpoint of environmental protection.

Although the present disclosure has been specifically described on the basis of this exemplary embodiment, the disclosure is not to be construed as being limited thereto. Various changes or modifications may be made to the embodiment without departing from the scope and spirit of the disclosure.

What is claimed is:

1. A light source structure of a projector, comprising:
a solid state lighting element generating a plurality of radial beams;
an optical collimator lens positioned on a light path of the radial beams; and
a micro-lens aligned with the solid state lighting element and the optical collimator lens;
wherein the radial beams strike the optical collimator lens where the radial beams are converted into a plurality of parallel beams, which is transmitted to the micro-lens and are focused by the micro-lens into a projecting beam.

2. The light source structure of claim 1, wherein the optical collimator lens is positioned in front of and aligned with the solid state lighting element, and the optical collimator lens comprises a first incident surface facing the solid state lighting element and a first exiting surface opposite to the first incident surface.

3. The light source structure of claim 2, wherein the micro-lens is positioned in front of and aligned with the optical collimator lens, and the micro-lens comprises a second incident surface facing the first exiting surface of the optical collimator lens.

4. The light source structure of claim 4, wherein the solid state light element comprises light emitting diode.

5. The light source structure of claim 4, wherein the solid state light element comprises laser diode.

6. A light source structure of a projector, comprising:
a solid state lighting array comprising a plurality of solid state lighting elements to generate a plurality of radial beams;
an optical collimator lens array comprising a plurality of optical collimator lenses positioned on a light path of the radial beams; and
a micro-lens array comprising a plurality of micro-lenses that each micro-lens is aligned with a corresponding solid state lighting element and a corresponding optical collimator lens;
wherein the radial beams strike the optical collimator lens array where the radial beams are converted into a plurality of parallel beams, which transmit to the micro-lens array and are focused by the micro-lens array into projecting beams.

7. The light source structure of claim 6, wherein the optical collimator lens array is positioned in front the solid state lighting array.

8. The light source structure of claim 7, wherein both of the optical collimator lens array and the micro-lens array are square arrays.

9. The light source structure of claim 8, wherein the optical collimator lens array is positioned in a lattice frame.

10. The light source structure of claim 9, wherein the micro-lens array is positioned in front of the optical collimator lens array.

11. The light source structure of claim 10, wherein the micro-lens array is a square array corresponding to the optical collimator lens array.

12. The light source structure of claim 10, wherein each optical collimator lens comprises a first incident surface facing the corresponding solid state lighting element and a first exiting surface opposite to the first incident surface.

13. The light source structure of claim 12, wherein each micro-lens comprises a second incident surface facing the first exiting surface of the corresponding optical collimator lens.

14. The light source structure of claim 6, wherein the solid state lighting elements are electrically connected.

15. The light source structure of claim 6, wherein each solid state light element comprises light emitting diode or laser diode.
